(19) United States
(12) Patent Application Publication
(10) Pub. No.: US 2003/0010171 A1
(43) Pub. Date: Jan. 16, 2003

(54) Handle and motor housing structure of a circular sawing machine

(76) Inventor: Lai-Jin Liu, Taichung Hsien (TW)

Correspondence Address: CONNOLLY BOVE LODGE & HUTZ, LLP, 1220 N MARKET STREET, P O BOX 2207, WILMINGTON, DE, 19899

(21) Appl. No.: 09/978,466

(22) Filed: Oct. 17, 2001

(30) Foreign Application Priority Data
Jul. 12, 2001 (TW) 90211918

(51) Int. Cl. B23D 45/04

(52) U.S. Cl. 83/490

(57) ABSTRACT

A handle and motor housing structure of a circular sawing machine includes a hollow motor housing having a front side integrally formed with a handle lower casing plate. A handle upper casing plate is secured on the handle lower casing plate, such that the handle upper casing plate may be integrally screwed with the handle lower casing plate which is integrally formed with the front side of the hollow motor housing. Thus, the motor housing is integrally formed with the handle lower casing plate to form a modularized structure, thereby efficiently enhancing the assembly efficiency of the motor coil circuit and the press switch, and thereby further increasing the stability and rigidity of the press operation of the circular sawing machine.

### BACKGROUND OF THE INVENTION

1. Field of the Invention

The present invention relates to a handle and motor housing structure of a circular sawing machine, and more particularly to a handle and motor housing structure of a circular sawing machine, wherein the motor housing is integrally formed with the handle lower casing plate to form a modularized structure, thereby efficiently enhancing the assembly efficiency of the motor coil circuit and the press switch, and thereby further increasing the stability and rigidity of the press operation of the circular sawing machine.

2. Description of the Related Art

A conventional circular sawing machine in accordance with the prior art comprises a motor housing, and a handle attached to the motor housing. The handle and the motor housing are manufactured and formed respectively, and the handle is then screwed on the motor housing, and then connected to the related electronic circuits, thereby forming a structure for pressing and operating the circular sawing machine.

However, it is difficult to mount and connect complicated motor coil circuits and switch circuits between the motor housing and the handle that are separated from each other, thereby causing inconvenience in the assembly work. In addition, the handle is screwed on the motor housing, so that when the circular sawing machine is used to strongly cut the workpiece reciprocally, the handle is easily detached from the motor housing due to the large vibration produced during long-term utilization, thereby decreasing the efficiency of the cutting work.

### SUMMARY OF THE INVENTION

The present invention has arisen to mitigate and/or obviate the disadvantage of the conventional circular sawing machine.

The primary objective of the present invention is to provide a handle and motor housing structure of a circular sawing machine, wherein the motor housing is integrally formed with the handle lower casing plate to form a modularized structure, thereby efficiently enhancing the assembly efficiency of the motor coil circuit and the press switch, and thereby further increasing the stability and rigidity of the press operation of the circular sawing machine.

In accordance with the present invention, there is provided a handle and motor housing structure of a circular sawing machine, comprising:

a hollow motor housing having a front side integrally formed with a handle lower casing plate, a closed curved face formed between the hollow motor housing and the handle lower casing plate; and

a handle upper casing plate secured on the handle lower casing plate, so that the handle upper casing plate may be integrally screwed with the handle lower casing plate which is integrally formed with the front side of the hollow motor housing.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a handle and motor housing structure of a circular sawing machine in accordance with the present invention;

FIG. 2 is a perspective assembly view of the handle and motor housing structure of a circular sawing machine as shown in FIG. 1; and

FIG. 3 is a schematic assembly view of the handle and motor housing structure of a circular sawing machine as shown in FIG. 2 in use.

### DETAILED DESCRIPTION OF THE INVENTION

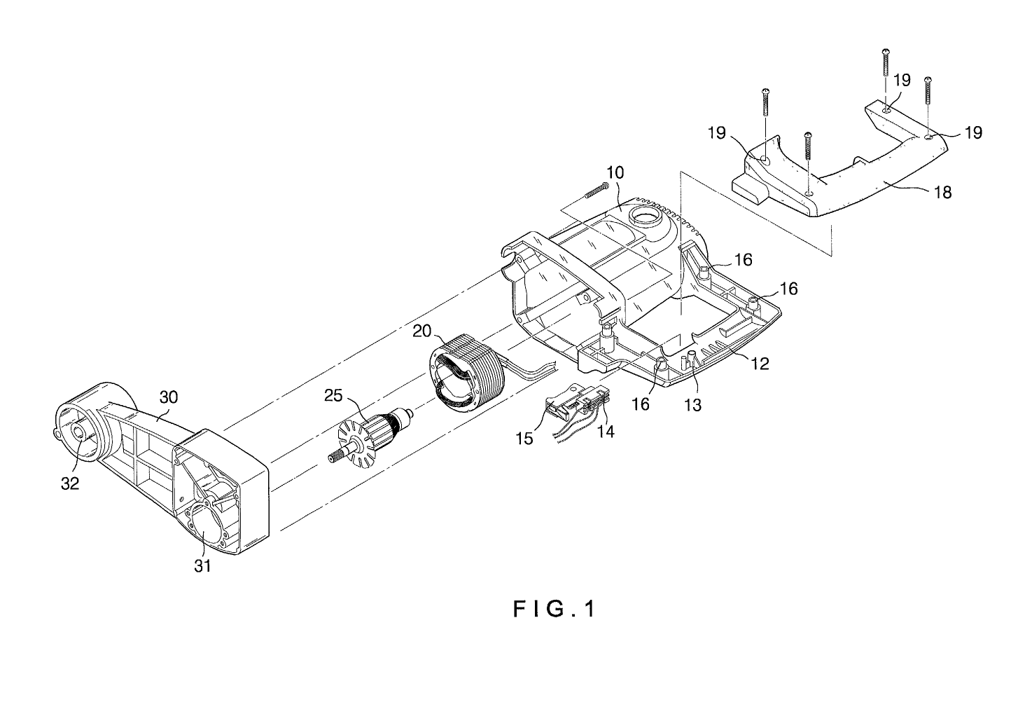

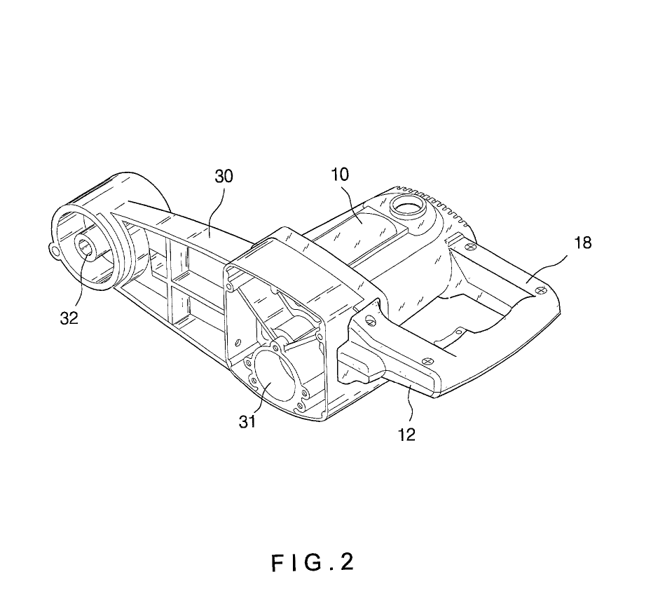

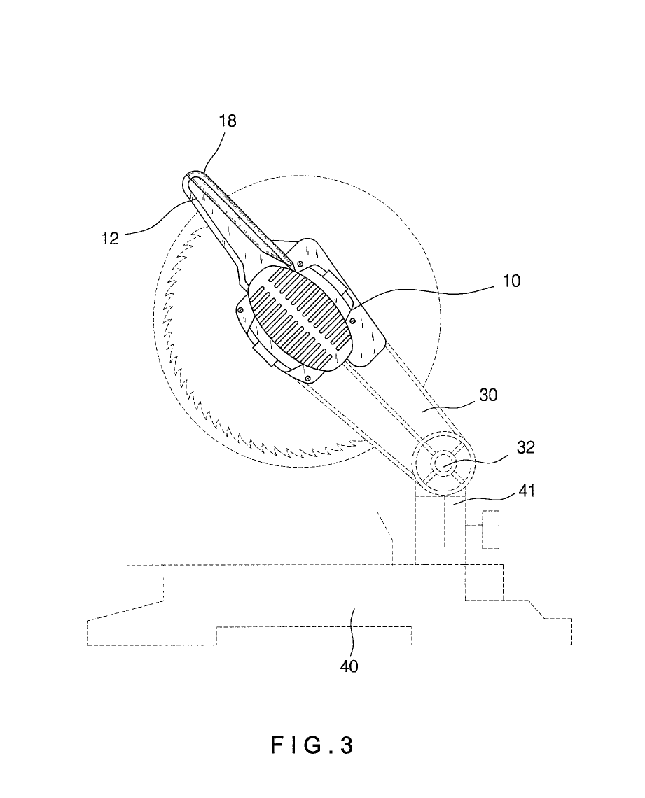

Referring to the drawings and initially to FIGS. 1-3, a handle and motor housing structure of a circular sawing machine in accordance with the preferred embodiment of the present invention comprises a hollow motor housing 10 having a front side integrally formed with a substantially horizontal U-shaped handle lower casing plate 12, and a closed curved face is formed between the hollow motor housing 10 and the handle lower casing plate 12.

A press switch 14 is secured on a positioning post 13 of the handle lower casing plate 12, and has a press plate 15 locally protruded outward from an inner edge end of the handle lower casing plate 12, thereby facilitating the holding, pressing and operating actions of the user.

A handle upper casing plate 18 is secured on the handle lower casing plate 12, and defines multiple screw holes 19. The handle lower casing plate 12 is provide with multiple threaded posts 16 screwed in the screw holes 19 of the handle upper casing plate 18. The handle upper casing plate 18 is substantially U-shaped, so that the handle upper casing plate 18 may be integrally screwed with the handle lower casing plate 12 which is horizontally formed with the front side of the hollow motor housing 10.

Thus, according to the present invention, the motor housing 10 is integrally formed with the handle lower casing plate 12 to form a modularized structure, thereby efficiently enhancing the assembly efficiency of the motor coil circuit and the press switch 14, and thereby further increasing the stability and rigidity of the press operation of the circular sawing machine. Therefore, the handle and motor housing structure of the circular sawing machine in accordance with the present invention can entirely avoid the problem arising in the conventional circular sawing machine, wherein the conventional handle is easily loosened from the conventional motor housing.

Subsequently, a motor stator 20 and a motor rotor 25 are mounted in the motor housing 10. A cantilever seat 30 of the circular sawing machine has a top edge having a side end screwed on an end side of the motor housing 10. The top edge of the cantilever seat 30 defines a circular hole 31 for receiving a saw blade linking mechanism (not shown) which may be driven by the motor rotor 25. A working table 40 of the circular sawing machine has a rear side provided with a pivot seat 41, and the cantilever seat 30 has a bottom edge defining a pivot hole 32 rotatably mounted on the pivot seat 41 of the working table 40.

Accordingly, in the handle and motor housing structure of a circular sawing machine in accordance with the present invention, the motor housing is integrally formed with the handle lower casing plate, to form a modularized structure, such that connection and assembly of the motor coil circuit and the press switch are more convenient and precise, thereby greatly enhancing the assembly efficiency of the motor coil circuit and the press switch, and thereby further increasing the stability and rigidity of the press operation of the circular sawing machine.

In addition, the present invention does not have the same structure as that of the conventional circular sawing machine, wherein the conventional handle is screwed with the conventional motor housing. Thus, in the present invention, the motor housing 10 is not screwed with the handle lower casing plate 12 or the handle upper casing plate 18, so that the detachment situation of the screwing structure will not happen between the motor housing 10 and the handle lower casing plate 12 or the handle upper casing plate 18.

Further, the motor housing 10 is integrally formed with the handle, so that the circular sawing machine in accordance with the present invention may be stably and rigidly operated under the condition of strongly sawing and cutting the workpiece with a violent vibration during a long period of time, thereby enhancing the efficiency and quality of the sawing and cutting work.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A handle and motor housing structure of a circular sawing machine, comprising:
a hollow motor housing having a front side integrally formed with a handle lower casing plate, a closed curved face formed between the hollow motor housing and the handle lower casing plate; and
a handle upper casing plate secured on the handle lower casing plate, so that the handle upper casing plate may be integrally screwed with the handle lower casing plate which is integrally formed with the front side of the hollow motor housing.

2. The handle and motor housing structure of a circular sawing machine in accordance with claim 1, wherein the handle lower casing plate integrally formed with the hollow motor housing is substantially U-shaped.

3. The handle and motor housing structure of a circular sawing machine in accordance with claim 1, further comprising a press switch secured on the handle lower casing plate.

4. The handle and motor housing structure of a circular sawing machine in accordance with claim 1, wherein the handle upper casing plate is substantially U-shaped.

5. The handle and motor housing structure of a circular sawing machine in accordance with claim 1, further comprising a motor stator and a motor rotor mounted in the motor housing.

6. The handle and motor housing structure of a circular sawing machine in accordance with claim 1, further comprising a cantilever seat having a top edge having a side end screwed on an end side of the motor housing.
